(19) United States
(12) Patent Application Publication
(10) Pub. No.: US 2023/0088499 A1
(43) Pub. Date: Mar. 23, 2023

(54) POWDERED COMPOSITION

(71) Applicant: FIRMENICH SA, Satigny (CH)

(72) Inventors: Jian ZHANG, Plainsboro, NJ (US); Amanda SCHOBER, Plainsboro, NJ (US); Howard MUNT, Satigny (CH); Cornelius ELIE, Satigny (CH)

(21) Appl. No.: 17/904,551

(22) PCT Filed: Feb. 17, 2021
(86) PCT No.: PCT/EP2021/053832

§ 371 Date: Aug. 18, 2022

Related U.S. Application Data
(60) Provisional application No. 62/979,019, filed on Feb. 20, 2020.

(30) Foreign Application Priority Data
Mar. 19, 2020 (EP) 20164293.1

(51) Int. Cl. A23L 27/00; A23J 3/14; A23J 3/30

(52) U.S. Cl. CPC A23L 27/70; A23J 3/14; A23J 3/30

(57) ABSTRACT

Described herein is a composition including a carrier including a plant-based protein, and an active ingredient including a flavor or a perfume.

### FIELD

The present disclosure provides a composition comprising a carrier comprising a plant-based protein, and an active ingredient comprising a flavor or a perfume. A process for preparing the composition and consumer products containing the composition are also objects of the present disclosure.

### BACKGROUND

The consumer demand for “clean label” or “natural” delivery systems is more and more important and is driving therefore the development of new delivery systems. Dried particles are commonly prepared from a liquid emulsion that is then dried via different methods (e.g., spray drying, extrusion, fluidizing bed drying, etc.). Most of the emulsions comprise a carrier, and an active ingredient, such as flavors or fragrances.

Plant-based proteins are useful as carriers in many categories where “clean label” or “natural” delivery systems are employed, such as, for example, protein powders, protein drinks, protein bars, meat proteins, meat analogues, and the like. Non-allergenic plant proteins (such as, for example, pea protein, lentil protein, rice protein, potato protein, chickpea protein, fava bean protein, mung bean protein, sunflower seed protein, pumpkin seed protein, flax protein, chia protein, canola protein, lupine protein, alfalfa protein, moringa protein, and the like) are particularly useful.

However, the substitution of traditional carriers (such as, for example, maltodextrin or modified starch) with plant-based proteins frequently results in poor retention of the at least one active ingredient. Additionally, the solubility and/or viscosity of the plant-based proteins used as carriers also adversely impact the retention of the at least one active ingredient.

For example, J. Agric. Food Chem. 2009, 57, 2486-2492, entitled “Encapsulation Performance of Proteins and Traditional Materials for Spray Dried Flavors” discloses methods to generate spray-dried compositions comprising sodium caseinate, whey, or soy protein isolate, in comparison with gum arabic and modified starch.

In another example, U.S. Patent Application Publication No. US 2009/0238885 A1 discloses a method for producing encapsulated protein particles. More specifically, it involves spraying and drying activated protein solution having a reactivity of at least 0.1 mM thiol sulphydryl groups per 2% protein solution, as determined by Ellman's assay.

In another example, Food Bioprocess Technol. 2015, 8(12) (2015): 2418-2428, entitled “Pea protein isolates: Novel wall materials for microencapsulating flaxseed oil.” discloses the spray dry encapsulation performance of flaxseed oil in different pea protein matrices.

In another example, Food and Bioprocess Technology, 2012, 5(6), 2211-2221, entitled “Pea (Pisum sativum, L.) protein isolate stabilized emulsions: a novel system for microencapsulation of lipophilic ingredients by spray drying” discloses to the spray dry encapsulation performance of medium chain triglycerides (MCT) using pea protein as emulsifier and starch hydrolysate as matrices.

None of the compositions described above were able to afford high active ingredient retention and/or high-throughput, due, in part to the low water solubility and high viscosity of the proteins used as carriers.

Accordingly, there is a need for plant protein carriers affording high active ingredient retention (greater than 70%) at high protein concentration (greater than or equal to 15% by weight) for spray dry encapsulation.

### SUMMARY

The present disclosure solves the above-mentioned problems by providing a powdered composition with good performance. In particular, the present disclosure provides optimal non-animal protein solubility and viscosity parameters for carriers that result in optimal retention of the active ingredient.

In one aspect, the present disclosure provides a composition comprising:
a) from 40 to 95% of a carrier comprising at least one non-animal protein, wherein:
   i. the at least one non-animal protein has a solubility of greater than or equal to 20% and less than 99%, preferably greater than or equal to 50% and less than 99%, when measured at a protein concentration of 5% w/w in an aqueous solution, pH 7, and 25° C.;
   ii. the non-animal protein has a viscosity of less than or equal to 400 mPa·s, when measured at 65° C. and shear rate of 50 s⁻¹, and a protein concentration of 15% w/w in an aqueous solution; and
b) from 5 to 60% of an at least one active ingredient,
   the percentages being defined by weight, relative to the total weight of the composition.

In one aspect, the composition comprises from 70 to 90% of the carrier.

In one aspect, the composition comprises from 10 to 30% of the at least one active ingredient.

In one aspect, the at least one active ingredient comprises a flavor oil.

In one aspect, the carrier comprises from 2 to 80% of an at least one non-animal protein and from 20 to 98% soluble food materials, the percentages being defined by weight, relative to the total weight of the carrier.

In one aspect, the at least one non-animal protein is selected from the group consisting of: pea protein, lentil protein, rice protein, potato protein, chickpea protein, fava bean protein, mung bean protein, sunflower seed protein, pumpkin seed protein, flax protein, chia protein, canola protein, lupine protein, alfalfa protein, moringa protein, and combinations thereof.

In one aspect, the at least one non-animal protein comprises a single non-animal protein.

In one aspect, the at least one non-animal protein comprises at least one non-animal protein.

In one aspect, the at least one non-animal protein is hydrolysed.

In one aspect, the soluble food materials are selected from the group consisting of: starch hydrolysate, soluble fibers, sugars, soluble polysaccharides, exudate gums, gum arabic, inulin, beta-glucan, psyllium, glucomannan, arabinogalactan, soluble corn fiber, resistant starch, and combinations thereof.

In one aspect, the present disclosure provides a flavored article comprising a composition according to an aspect presented herein.

In one aspect, the flavored article is selected from the group consisting of: protein powders, protein drinks, protein bars, meat analogues, and savory goods.

### BRIEF DESCRIPTION OF THE FIGURES

While the specification concludes with claims particularly pointing out and distinctly claiming the invention, it is believed that the invention will be better understood from the following description of the accompanying figures wherein:

FIG. 1 shows orange oil retention as a function of protein solubility in the spray-dried compositions described in Example 1.

FIG. 2 shows orange oil retention as a function of protein content in the carrier of the spray-dried compositions described in Example 2.

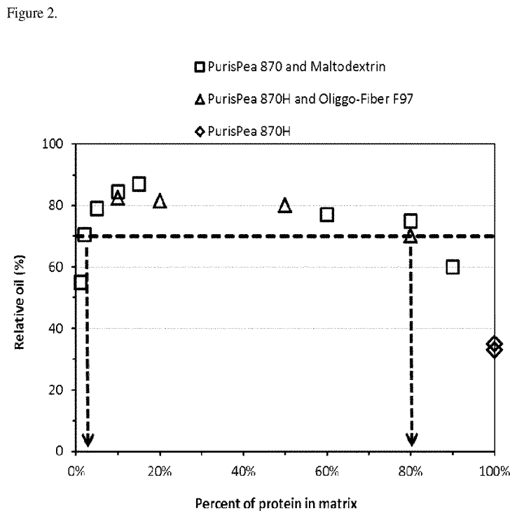

### DETAILED DESCRIPTION

In the following description, reference is made to specific embodiments which may be practiced, which is shown by way of illustration. These embodiments are described in detail to enable those skilled in the art to practice the invention described herein, and it is to be understood that other embodiments may be utilized and that logical changes may be made without departing from the scope of the aspects presented herein. The following description of example embodiments is, therefore, not to be taken in a limited sense, and the scope of the various aspects presented herein is defined by the appended claims.

The Abstract is provided to comply with 37 C.F.R. § 1.72(b) to allow the reader to quickly ascertain the nature and gist of the technical disclosure. The Abstract is submitted with the understanding that it will not be used to interpret or limit the scope or meaning of the claims.

Unless stated otherwise, percentages (%) are meant to designate a percentage by weight of a composition.

It should be understood that the total amount of ingredients in the composition or emulsion is 100%.

“Powdered composition” and “dried particles” are used interchangeably according to the present disclosure.

The Composition

In one aspect, the present disclosure provides a composition comprising:
a) from 40 to 95% of a carrier comprising at least one non-animal protein, wherein:
   i. the at least one non-animal protein has a solubility of greater than or equal to 20% and less than 99%, preferably greater than or equal to 50% and less than 99%, when measured at a protein concentration of 5% w/w in an aqueous solution, pH 7, and 25° C.;
   ii. the non-animal protein has a viscosity of less than or equal to 400 mPa·s, when measured at 65° C. and shear rate of 50 s⁻¹, and a protein concentration of 15% w/w in an aqueous solution; and
b) from 5 to 60% of an at least one active ingredient,
   the percentages being defined by weight, relative to the total weight of the composition.

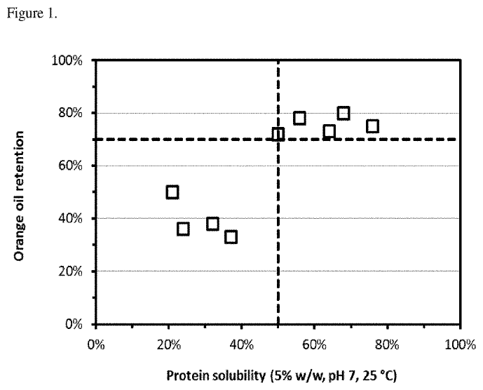

Referring to Example 1 and FIG. 1, in order to achieve retention levels of the at least one active ingredient of 70% or greater, the at least one non-animal protein used as a carrier had a solubility of greater than or equal to 50% and less than 99%, when measured at a protein concentration of 5% w/w in an aqueous solution.

In some aspects, the composition further comprises an emulsifier.

Without intending to be limited to any particular theory, the composition of the at least one non-animal protein may be selected to obtain the desired solubility and/or viscosity. For example, in some aspects, the at least one non-animal protein comprises a single non-animal protein.

In alternate aspects, the at least one non-animal protein comprises a mixture of non-animal proteins. The non-animal proteins may be non-hydrolyzed, or hydrolyzed. In some aspects, the hydrolysis is partial (i.e., less than 100% hydrolyzed).

In some aspects, the at least one non-animal protein is hydrolyzed. In some aspects, the hydrolysis is partial (i.e., less than 100% hydrolyzed).

In some aspects, the at least one non-animal protein is treated with protease in an amount and time sufficient to modify the solubility of the at least one non-animal protein, such that the solubility of the at least one non-animal protein is greater than or equal to 20% and less than 99%, preferably greater than or equal to 50% and less than 99%, when measured at a protein concentration of 5% w/w, pH 7, and 25° C. in an aqueous solution.

In some aspects, the at least one non-animal protein is treated with protease in an amount and time sufficient to modify the viscosity of the at least one non-animal protein, such that the viscosity of the at least one non-animal protein is less than or equal to 400 mPa^{s}, when measured at 65° C. and shear rate of 50 s⁻¹, and a protein concentration of 15% w/w in an aqueous solution.

In some aspects, the at least one non-animal protein is treated with a protease prior to forming the composition. Without intending to be limited to any particular theory, protease treatment hydrolyses the at least one non-animal protein partially (i.e. less than 100%), and the partial hydrolysis reduces the viscosity and/or increases the solubility of the at least one non-animal protein, thereby increasing the retention of the at least one active ingredient.

According to an embodiment, the non-animal protein is subjected to a heating process. Without intending to be limited to any particular theory, it has been surprisingly found that the non-animal protein in the present invention can act not only as a carrier material but also at the same time imparts the flavor to the composition via Maillard reaction which take place during a heating process (typically between 100 and 125° C. during 1 to 3 hours).

In some aspects, the composition comprises from 40 to 95, or, alternatively, from 40 to 90, or, alternatively, from 40 to 85, or, alternatively, from 40 to 80, or, alternatively, from 40 to 75, or, alternatively, from 40 to 70, or, alternatively, from 40 to 65, or, alternatively, from 40 to 60, or, alternatively, from 40 to 55% of the carrier, or, alternatively, from 40 to 50, or, alternatively, from 40 to 45% of the carrier, the percentages being defined by weight, relative to the total weight of the composition.

In some aspects, the composition comprises from 45 to 95, or, alternatively, from 50 to 95, or, alternatively, from 55 to 95, or, alternatively, from 60 to 95, or, alternatively, from 65 to 95, or, alternatively, from 70 to 95, or, alternatively, from 75 to 95, or, alternatively, from 80 to 95, or, alternatively, from 85 to 95, or, alternatively, from 90 to 95% of the carrier, the percentages being defined by weight, relative to the total weight of the composition.

In some aspects, the composition comprises from 70 to 90% of the carrier, the percentages being defined by weight, relative to the total weight of the composition.

Without intending to be limited to any particular theory, addition of soluble food materials to the carrier also increase the retention of the at least one active ingredient. Accordingly, in one aspect, the carrier comprises from 2 to 80% of the at least one non-animal protein and from 20 to 98% soluble food materials, the percentages being defined by weight, relative to the total weight of the carrier.

In some aspects, the carrier comprises from 10 to 80% of the at least one non-animal protein and from 20 to 90% soluble food materials, the percentages being defined by weight, relative to the total weight of the carrier.

In one aspect, the carrier comprises from 5 to 60% soluble food materials. In an alternate aspect, the carrier comprises from 10 to 60% soluble food materials, the percentages being defined by weight, relative to the total weight of the carrier.

In one aspect, the soluble food materials are selected from the group consisting of: starch hydrolysate, soluble fibers, sugars, soluble polysaccharides, exudate gums, gum arabic, inulin, beta-glucan, psyllium, glucomannan, arabinogalactan, soluble corn fiber, resistant starch, and combinations thereof.

In one aspect, the carrier consists of at least one non-animal protein.

In one aspect, the carrier is essentially free from starch hydrolysate (such as modified starch or maltodextrins) and/or gum Arabic. By “essentially free”, it means that the carrier comprises less than 5%, preferably less than 2%, even more preferably less than 1% by weight based on the total weight of the carrier. In one aspect, the carrier is free from starch hydrolysate (such as modified starch or maltodextrins) and/or gum Arabic.

In some aspects, the at least one non-animal protein is selected from the group consisting of: pea protein, lentil protein, rice protein, potato protein, chickpea protein, fava bean protein, mung bean protein, sunflower seed protein, pumpkin seed protein, flax protein, chia protein, canola protein, lupine protein, alfalfa protein, moringa protein, and combinations thereof.

In some aspects, the at least one non-animal protein is non-allergenic. Examples of non-allergenic non-animal proteins include, but are not limited to pea protein, lentil protein, rice protein, potato protein, chickpea protein, fava bean protein, mung bean protein, sunflower seed protein, pumpkin seed protein, flax protein, chia protein, canola protein, lupine protein, alfalfa protein, moringa protein, and combinations thereof.

### The at Least One Active Ingredient

Active ingredients comprise flavoring and/or perfuming ingredients that are preferably subject to oxidation (“oxidizable”) and encompass both flavor and fragrance ingredients or compositions of current use in the flavor and/or fragrance industry, including those of natural or synthetic origin and in the form of single compounds or mixtures thereof. Specific examples of such flavor and/or fragrance ingredients may be found in the current literature, e.g. in Fenaroli's Handbook of flavor ingredients, 1975, CRC Press; Synthetic Food adjuncts, 1947 by M. B. Jacobs, edited by Van Nostrand; or Perfume and Flavor Chemicals by S. Arctander, 1969, Montclair, N.J. (USA). Many other examples of current flavoring and/or perfuming ingredients may be found in the patent and general literature available. The flavoring and/or perfuming ingredients may be present in the form of a mixture with solvents, adjuvants, additives and/or other components, generally those of current use in the flavor and fragrance industry.

“Flavoring ingredients” as used herein are compounds that are well known to a person skilled in the art of aromatising as those that are capable of imparting a flavor or taste to a consumer product, or of modifying the taste and/or flavor of the consumer product, or yet its texture or mouthfeel. The flavoring ingredient may be a taste modifier or a taste compound.

Examples of taste compounds are salt, inorganic salts, organic acids, sugars, amino acids and their salts, ribonucleotides, and sources thereof.

A “taste modifier” is understood as an active ingredient that operates on a consumer's taste receptors, or provides a sensory characteristic related to mouthfeel (such as body, roundness, or mouth-coating) to a product being consumed. Non-limiting examples of taste modifiers include active ingredients that enhance, modify or impart saltiness, fattiness, umami, kokumi, heat sensation or cooling sensation, sweetness, acidity, tingling, bitterness or sourness.

The term “perfuming ingredients” is understood to mean compounds which are used as active ingredients in perfuming preparations or compositions in order to impart a hedonic effect when applied on a surface. In other words, such compounds, to be considered as being perfuming ones, must be recognized by a person skilled in the art of perfumery as being able to impart or modify in a positive or pleasant way the odor of a composition or of an article or surface, and not just as having an odor. Moreover, this definition is also meant to include compounds that do not necessarily have an odor but are capable of modulating the odor of a perfuming composition, perfumed article or surface and, as a result, of modifying the perception by a user of the odor of such a composition, article or surface. It also contains malodor counteracting ingredients and compositions. By the term “malodor counteracting ingredient” we mean here compounds which are capable of reducing the perception of malodor, i.e., of an odor that is unpleasant or offensive to the human nose by counteracting and/or masking malodors. In a particular embodiment, these compounds have the ability to react with key compounds causing known malodors. The reactions result in reduction of the malodor materials' airborne levels and consequent reduction in the perception of the malodor.

Flavors that are derived from or based fruits where citric acid is the predominant, naturally-occurring acid include but are not limited to, for example, citrus fruits (e.g., lemon, lime), limonene, strawberry, orange, and pineapple. In one aspect, the flavors food is lemon, lime or organge juice extracted directly from the fruit. Further aspects of the flavor comprise the juice or liquid extracted from oranges, lemons, grapefruits, key limes, citrons, clementines, mandarins, tangerines, and any other citrus fruit, or variation or hybrid thereof. In a particular aspect, the flavor comprises a liquid extracted or distilled from oranges, lemons, grapefruits, key limes, citrons, clementines, mandarins, tangerines, any other citrus fruit or variation or hybrid thereof, pomegranates, kiwifruits, watermelons, apples, bananas, blueberries, melons, ginger, bell peppers, cucumbers, passion fruits, mangos, pears, tomatoes, and strawberries.

In some aspects, the composition comprises from 5 to 50, or, alternatively, from 5 to 45, or, alternatively, from 5 to 40, or, alternatively, from 5 to 35, or, alternatively, from 5 to 30, or, alternatively, from 5 to 25, or, alternatively, from 5 to 20, or, alternatively, from 5 to 15, or, alternatively, from 5 to 10% of the at least one active ingredient, the percentages being defined by weight, relative to the total weight of the composition.

In some aspects, the composition comprises from 10 to 50, or, alternatively, from 15 to 50, or, alternatively, from 20 to 50, or, alternatively, from 25 to 50, or, alternatively, from 30 to 50, or, alternatively, from 35 to 50, or, alternatively, from 40 to 50, or, alternatively, from 55 to 50% of the at least one active ingredient, the percentages being defined by weight, relative to the total weight of the composition.

In some aspects, the composition comprises from 10 to 30% of the at least one active ingredient.

In some aspects, the at least one active ingredient comprises a flavor oil.

### Methods

The composition may be prepared by any suitable method readily selected by one of ordinary skill in the art. Non-limiting examples of methods include extrusion, spray drying, and the like.

According to an embodiment, the composition is prepared by spray drying according to the methods disclosed in U.S. Patent Application Publication No. 2015/0374018 A1.

In one aspect, the present disclosure provides a method comprising the steps of:
1. preparing an emulsion comprising:
   a) from 7.5 to 47.5% of a carrier comprising at least one non-animal protein, wherein:
      i. the at least one non-animal protein has a solubility of greater than or equal to 20% and less than 99%, preferably greater than or equal to 50% and less than 99%, when measured at a protein concentration of 5% w/w, pH 7, and 25° C. in an aqueous solution;
   b) the at least one non-animal protein has a viscosity of less than or equal to 400 mPa^{s}, when measured at 65° C. and shear rate of 50 s⁻¹, and a protein concentration of 15% w/w in an aqueous solution; from 0.75 to 30% of an active ingredient,
      the percentages being defined by weight, relative to the total weight of the composition.
   c) From 50 to 85% water;
2. drying the emulsion obtained in step 1 so as to obtain a powdered composition.

The emulsion can be formed using any known emulsifying method, such as high shear mixing, sonication or homogenization. Such emulsifying methods are well known to the person skilled in the art.

In one aspect, the composition is formed by spray drying a feed emulsion in which the solids content (the mass of carrier divided by the total mass of carrier and water) is greater than or equal to 15%. One example of spray drying method can be found in International Patent Application Publication No. WO 2019/162475 A1. Without intending to be limited to any particular theory, the compositions disclosed herein optimize retention of the at least one active ingredient. Active ingredient retention may be affected by parameters such as, for example, the solubility of the protein carrier and the viscosity of the protein carrier.

When spray-drying is used, the emulsion is first subjected to a spraying step during which the emulsion is dispersed in the form of drops into a spraying tower. Any device capable of dispersing the emulsion in the form of drops can be used to carry out such dispersion. For instance, the emulsion can be guided through a spraying nozzle or through a centrifugal wheel disk. Vibrated orifices may also be used.

In one aspect of the invention the emulsion is dispersed in the form of drops into a cloud of powdering agent present in the dry tower. Such type of process is for example described in details in WO2007/054853 or in WO2007/135583.

For a specific formulation, the size of the particles is influenced by the size of the drops that are dispersed into the tower. When a spraying nozzle is used for dispersing the drops, the size of such drops can be controlled by the flow rate of an atomising gas through the nozzle, for example. In the case where a centrifugal wheel disk is used for dispersal, the main factor for adjusting droplet size is the centrifugal force with which the drops are dispersed from the disk into the tower. The centrifugal force, in turn, depends on the speed of rotation and the diameter of the disk. The feed flow rate of the emulsion, its surface tension and its viscosity are also parameters controlling the final drop size and size distribution. By adjusting these parameters, the skilled person can control the size of the drops of the emulsion to be dispersed in the tower.

Once sprayed in the chamber, the droplets are dried using any technique known in the art. These methods are perfectly documented in the patent and non-patent literature in the art of spray-drying. For example, Spray-Drying Handbook, 3rd ed., K. Masters; John Wiley (1979), describes a wide variety of spray-drying methods.

The process of the present invention may be performed in any conventional spraying tower. A conventional multi-stage drying apparatus is for example appropriate for conducting the steps of this process. It may comprise a spraying tower, and, at the bottom of the tower, a fluidised bed intercepting partially dried particles after falling through the tower.

The amount of flavor or fragrance lost during the spray drying step is below 30%, alternatively below 20%, alternatively below 10%, these percentages being defined by weight, relative to the theoretical amount that would be present in the particles if there was absolutely no flavor or fragrance lost during the spray-drying step.

### Flavored Article

Another object of the invention is a consumer product comprising the composition of the invention. Preferably such product is a flavored or fragranced product.

In one aspect, the present disclosure provides a flavored article comprising a composition according to an aspect presented herein.

In one aspect, the flavored article is selected from the group consisting of: protein powders, protein drinks, protein bars, meat analogues, seefood analogues and savory goods.

Meat analogues can include pork analogues, venison analogues, beef analogues, veal analogues, rabbit analogues, sausage analogues, deli meat analogues, ham analogues, salami analogues, pepperoni analogues, chicken analogues, turkey analogues, goose analogues, pheasant analogues, pigeon analogues, whale analogues, lamb analogues, goat analogues, donkey analogues, and squirrel analogues.

Seafood analogues can include fish analogues, scallop analogues, shrimp analogues, crabmeat analogues, shellfish analogues, clam analogues, squid analogues, conch analogues, and sea pineapple analogues.

When the flavored article is a particulate or powdery food, the dry particles may easily be added thereto by dry-mixing. Typical flavored articles are selected from the group consisting of an instant soup or sauce, a breakfast cereal, a powdered milk, a baby food, a powdered drink, a powdered chocolate drink, a spread, a powdered cereal drink, a chewing gum, an effervescent tablet, a cereal bar, and a chocolate bar. The powdered foods or drinks may be intended to be consumed after reconstitution of the product with water, milk and/or a juice, or another aqueous liquid.

The dry particles provided herein may be suitable for conveying flavors to beverages, fluid dairy products, condiments, baked goods, frostings, bakery fillings, candy, chewing gum and other food products.

Beverages include, without limitation, carbonated soft drinks, including cola, lemon-lime, root beer, heavy citrus (“dew type”), fruit flavored and cream sodas; powdered soft drinks, as well as liquid concentrates such as fountain syrups and cordials; coffee and coffee-based drinks, coffee substitutes and cereal-based beverages; teas, including dry mix products as well as ready-to-drink teas (herbal and tealeaf based); fruit and vegetable juices and juice flavored beverages as well as juice drinks, nectars, concentrates, punches and “ades”; sweetened and flavored waters, both carbonated and still; sport/energy/health drinks; alcoholic beverages plus alcohol-free and other low-alcohol products including beer and malt beverages, cider, and wines (still, sparkling, fortified wines and wine coolers); other beverages processed with heating (infusions, pasteurization, ultra-high temperature, ohmic heating or commercial aseptic sterilization) and hot-filled packaging; and cold-filled products made through filtration or other preservation techniques.

Fluid dairy products include, without limitation, non-frozen, partially frozen and frozen fluid dairy products such as, for example, milks, ice creams, sorbets and yogurts.

Condiments include, without limitation, ketchup, mayonnaise, salad dressing, Worcestershire sauce, fruit-flavored sauce, chocolate sauce, tomato sauce, chili sauce, and mustard.

Baked goods include, without limitation, cakes, cookies, pastries, breads, donuts and the like.

Bakery fillings include, without limitation, low or neutral pH fillings, high, medium or low solids fillings, fruit or milk based (pudding type or mousse type) fillings, hot or cold make-up fillings and nonfat to full-fat fillings.

The composition of the invention can be of particular interest in the following examples of products:
Baked goods (e.g. bread, dry biscuits, cakes, other baked goods),
Cereal products (e.g. breakfast cereals, pre-cooked ready-made rice products, rice flour products, millet and sorghum products, raw or pre-cooked noodles and pasta products),
Milk products (e.g. fresh cheese, soft cheese, hard cheese, milk drinks, whey, butter, partially or wholly hydrolysed milk protein-containing products, fermented milk products, condensed milk and analogues),
Dairy based products (e.g. fruit or flavoured yoghurt, ice cream, fruit ices, frozen desserts)
Dairy analogues (imitation dairy products) containing non-dairy ingredients (plant-based proteins, vegetable fats),
Confectionary products (e.g. chewing gum, hard and soft candy),
Chocolate and compound coatings,
Products based on fat and oil or emulsions thereof (e.g. mayonnaise, spreads, margarines, shortenings, remoulade, dressings, spice preparations),
Spiced, marinated or processed fish products (e.g. fish sausage, surimi),
Eggs or egg products (dried egg, egg white, egg yolk, custard),
Desserts (e.g. gelatins and puddings),
Products made of soya protein or other soya bean fractions (e.g. soya milk and products made therefrom, soya lecithin-containing preparations, fermented products such as tofu or tempeh or products manufactured therefrom, soya sauces),
Vegetable preparations (e.g. ketchup, sauces, processed and reconstituted vegetables, dried vegetables, deep frozen vegetables, pre-cooked vegetables, vegetables pickled in vinegar, vegetable concentrates or pastes, cooked vegetables, potato preparations),
Spices or spice preparations (e.g. mustard preparations, horseradish preparations), spice mixtures and, in particular seasonings which are used, for example, in the field of snacks.
Snack articles (e.g. baked or fried potato crisps or potato dough products, bread dough products, extrudates based on maize, rice or ground nuts),
Ready dishes (e.g. instant noodles, rice, pasta, pizza, tortillas, wraps) and soups and broths (e.g. stock, savory cube, dried soups, instant soups, pre-cooked soups, retorted soups), sauces (instant sauces, dried sauces, ready-made sauces, gravies, sweet sauces).
Extended meat products (e.g. meat patties, sausages, chili, salisbury steaks, pizza toppings, meatballs, ground meat, bolognas, chicken nuggets, pork frankfurters, beef).

The present invention is best illustrated but is not limited to the following examples.

### EXAMPLES

### Example 1: Evaluation of Pea Proteins as Carriers in Compositions According to Several Aspects Presented Herein

Five commercial pea proteins from different vendors were obtained. The protein content and solubility were presented in the table below. All protein samples were analyzed for carbon, hydrogen, and nitrogen content. The total protein content was calculated using a multiplication factor on the nitrogen content. The general nitrogen to protein factor of 6.25 was used here. Protein solubility was determined by making up aqueous solutions containing 5% by weight of pea protein powder using deionized water at 25° C. The pH of the protein solutions was adjusted to 7 using 0.1 M hydrochloric acid or sodium hydroxide. After fully mixing and hydration of the protein, the aqueous solution was centrifuged to separate the soluble and insoluble fractions. After centrifugation, liquid supernatant (soluble fraction) was removed without obtaining any of the solids that precipitated at the bottom (insoluble fraction). The resultant supernatant was analyzed for nitrogen content. Protein content in the supernatant was then calculated based on nitrogen content using the factor of 6.25. Protein solubility is defined as the amount of protein in supernatant divided by the amount of protein in the whole aqueous solution.

| | | Protein content | Protein solubility |
|---|---|---|---|
| Pea proteins | Supplier | (w/w) | (5% w/w) |
| PurisPea 870H | Cargill | 78.5% | 37% |
| Nutralys S85F | Roquette | 78.2% | 21% |
| VegOtein P80 | Axiom | 79.7% | 24% |
| Pea Protein Isolate | Jiaherb Inc. | 76.4% | 32% |
| ProDiem ™ Refresh | Kerry | 82.0% | 100% |

Viscosity Measurements: Viscosity is an important parameter for spray drying. Lower viscosity and higher protein concentration are often desirable for spray drying encapsulation. The viscosity at different protein concentrations was measured at 65° C. and shear rate of 50 s⁻¹ using the Anton Paar MCR302 Rheometer (Anton Paar USA Inc., Ashland, Va.). All proteins were fully hydrated at 65° C. for 30 min with agitation, and then the protein solutions were held in water bath at 60-65° C. to separate the foam. The residue foam was removed from the top of the solution before viscosity measurement. The viscosity data is reported in the table below. Viscosity increased as protein concentration increased. Nutralys S85F, VegOtein P80 and Jiaherb Pea protein had high viscosity due to their low water solubility whereas PurisPea 870H had a lower viscosity due to its higher water solubility. ProDiem™ was completely soluble and accordingly had very low viscosity. A high viscosity does not allow spray drying at high protein concentrations which is undesirable from spray drying efficiency perspective.

| | Viscosity (mPa · s) at 65° C. and shear rate 50 s⁻¹ | | | | |
|---|---|---|---|---|---|
| Protein | | | | Jiaherb | |
| concen- | PurisPea | Nutralys | VegOtein | Pea | |
| tration | 870H | S85F | P80 | Protein | ProDiem ™ |
| 10.0% | | 70 | 66 | 7 | |
| 12.5% | | 184 | 275 | | |
| 15.0% | 31 | 910 | 1184 | 227 | |
| 17.5% | | 3073 | | | |
| 20.0% | 96 | | | 3738 | 1 |
| 22.5% | 188 | | | | |
| 25.0% | 356 | | | | |

Oil Retention: Orange oil was spray dried with pea proteins with 20% theoretical oil load. Different protein concentrations were used to ensure the viscosity was lower than 400 mPa s at 65° C. and shear rate 50 s⁻¹. Oil retention was defined as the ratio of retained oil in spray dried powder to the theoretical oil load. All spray dried powders (examples A, B, C and D) showed very low oil retention which is generally unacceptable for spray drying encapsulation. Therefore, there was a need to improve the oil retention. The poor oil retention may largely result from the poor water solubility of these plant proteins (less than 40% solubility measured at 5% w/w protein solution at 25° C.). Oil retention may be improved by increasing the water solubility of the proteins used for spray drying encapsulation.

| | | | | | Oil content in | |
|---|---|---|---|---|---|---|
| | | Feed emulsion composition | | | powder | Oil |
| Samples | Protein type | Orange oil | Protein | Water | (w/w) | retention |
| A | PurisPea 870H | 5% | 20% | 75% | 6.6% | 33% |
| B | Nutralys S85F | 3% | 12% | 85% | 10.0% | 50% |
| C | VegOtein P80 | 3% | 12% | 85% | 8.0% | 36% |
| D | Jiaherb Pea Protein | 4% | 16% | 80% | 7.6% | 38% |

Protein Blends as Carriers: To increase protein solubility, protein blends were used as a carrier to encapsulate orange oil. PurisPea 870H and ProDiem™ were blended at different ratios of 8:2, 7:3, and 5:5. The viscosity of these blends was measured at 15% protein concentration and all had a viscosity lower than 200 mPa s at 65° C. and shear rate 50 s⁻¹. The protein blends had water solubility of greater than 50% measured at 5% w/w protein solution at 25° C. Orange oil was spray dried with these protein blends and the results were reported in below table (examples E, F and G). As expected, oil retention of 70-80% was achieved as a result of the increased solubility of protein blends. The results support the hypothesis that protein solubility is critical in order to achieve high oil retention (e.g. greater than 70%) in spray drying encapsulation.

| | Feed emulsion composition | | | | Solubility of | Oil content | |
|---|---|---|---|---|---|---|---|
| | Orange | PurisPea | | | protein blend | in powder | Oil |
| Samples | oil | 870H | ProDiem ™ | Water | (5% w/w) | (w/w) | retention |
| E | 6% | 19.2% | 4.8% | 70% | 50% | 14.4% | 72% |
| F | 6% | 16.8% | 7.2% | 70% | 56% | 15.6% | 78% |
| G | 6% | 12.0% | 12.0% | 70% | 68% | 16.0% | 80% |

Pea Protein Hydrolysate as a Carrier: Protein solubility also can be improved by mild or partial hydrolysis by using protease. Protein hydrolysates were prepared by partial hydrolysis of 15% of Nutralys S85F with 0.5% protease and deionized water at 50° C. for 1 hour followed by enzyme inactivation at 85° C. for 30 min. Two proteases were selected including Protamex® and Neutrase® both of which were provided by Novozymes (Dittingen, Switzerland). The table below shows the viscosity and solubility of protein hydrolysates (examples H and I). Partial hydrolysis significantly reduced protein viscosity and increased protein solubility. Both hydrolysates had a viscosity less than 200 mPa s at 65° C. and shear rate 50 s⁻¹ measured at 15% protein concentration and protein solubility of greater than 60% measured at 5% w/w protein solution at 25° C.

| | | | | Viscosity of | Viscosity of | Solubility of |
|---|---|---|---|---|---|---|
| | | Protein | | protein before | protein | protein |
| | | concentration | | hydrolysis | hydrolysate | hydrolysate |
| Samples | Protein | (w/w) | Protease | (65° C. and 50 s⁻¹) | (65° C. and 50 s⁻¹) | (5% w/w) |
| H | Nutralys | 15% | Protamex ® | 910 mPa · s | 160 mPa · s | 64% |
| | S85F | | | | | |
| I | Nutralys | 15% | Neutrase ® | 910 mPa · s | 22 mPa · s | 76% |
| | S85F | | | | | |

Orange oil was spray dried with protein hydrolysates prepared in examples H and I with theoretical oil load of 20%. Examples J and K shows that high oil retention (greater than 70%) was achieved. In contrast, only 50% oil retention (example B) was obtained using Nutralys S85F without hydrolysis.

| | Feed emulsion composition | | |
|---|---|---|---|
| | | Hydrolysate of | |
| Samples | Orange oil | Nutralys S85F | Oil retention |
| J | 3.6% | 96.4% H | 73% |
| K | 3.6% | 96.4% I | 75% |

Attempt was also made to prepare prototypes with carrier of 100% ProDiem™ which is a protein hydrolysate and completely soluble in water (100% solubility at 5% w/w solution). The resultant powder was too hygroscopic and difficult to recover from the dryer under typical spray drying conditions. This is because ProDiem™ consists of mainly short chain peptides after extensive hydrolysis. In order to achieve good oil retention without compromising powder hygroscopicity, the hydrolysis has to be controlled to ensure the solubility of hydrolysate is less than 100%.

From examples A through K, it was found protein solubility is critical when using plant proteins as spray drying encapsulation carrier. This is clearly illustrated in FIG. 1. To achieve oil retention greater than 70%, solubility of proteins should be greater than 50%. One solution to increase protein solubility is partial hydrolysis of plant proteins by using protease. Conceivably, increase of protein solubility also can be achieved by acid hydrolysis or hydrolysis with plant extracts rich in protease (e.g. kiwi extract, pineapple extract, etc.).

### Example 2: Evaluation of Pea Protein and Other Soluble Food Materials Blends as Carriers in Compositions According to Several Aspects Presented Herein

Blends of pea proteins with other soluble materials (e.g. starch derivatives, fibers, etc.) were also evaluated for spray drying encapsulation. Blends of PurisPea 870H and maltodextrin 18 DE (obtained from Roquette) were prepared at different protein contents from 1% to 90% by weight (examples L to S). Orange oil was spray dried with these blends with theoretical oil load of 20%. It was found that oil retention increased from 55% to 87% when protein content increased from 1% to 50% (examples L, M, N, O and P).

| | Feed emulsion composition | | | | | Oil content | |
|---|---|---|---|---|---|---|---|
| | Orange | PurisPea | | | % protein in | in powder | Oil |
| Samples | oil | 870H | Maltodextrin | Water | carrier (w/w) | (w/w) | retention |
| L | 10% | 0.4% | 39.6% | 50% | 1% | 11.0% | 55% |
| M | 10% | 0.8% | 39.2% | 50% | 2% | 14.2% | 71% |
| N | 10% | 2% | 38% | 50% | 5% | 15.8% | 79% |
| O | 10% | 4% | 36% | 50% | 10% | 16.8% | 84% |
| P | 10% | 6% | 34% | 50% | 15% | 17.4% | 87% |
| Q | 8% | 19.2% | 12.8% | 60% | 60% | 15.4% | 77% |
| R | 6% | 19.2% | 4.8% | 70% | 80% | 15.0% | 75% |
| S | 5% | 18% | 2% | 75% | 90% | 12.0% | 60% |

Blends of pea proteins with Oliggo-Fiber F97 (Chickory Root fiber) were also evaluated for spray drying encapsulation. Blends of PurisPea 870H and Oliggo-Fiber F97 (obtained from Cargill) were prepared at different protein contents from 10% to 80% by weight (examples T to W). Orange oil was spray dried with these blends with theoretical oil load of 20%. All spray dried powders show oil retention equal to or greater than 70% (examples T, U, V and W).

| | Feed emulsion composition | | | | | Oil content | |
|---|---|---|---|---|---|---|---|
| | Orange | PurisPea | Oliggo- | | % protein in | in powder | Oil |
| Samples | oil | 870H | Fiber ® F97 | Water | carrier (w/w) | (w/w) | retention |
| T | 10.3% | 4.1% | 37.2% | 48.3% | 10% | 16.5% | 82% |
| U | 9.2% | 7.4% | 29.4% | 54.0% | 20% | 16.3% | 81% |
| V | 7.8% | 15.7% | 15.7% | 60.8% | 50% | 16.0% | 80% |
| W | 6.0% | 19.1% | 4.8% | 70.1% | 80% | 14.0% | 70% |

### Example 3: Evaluation of Pea Protein and Rice Protein as Carriers in Compositions According to Several Aspects Presented Herein

Pea Protein Isolate and Rice Protein Concentrate were also evaluated for spray drying encapsulation.

Vegetarian chicken flavor and vegetarian beef flavor were made through Maillard type of reactions at 121° C. for 1 hour. The resultant reaction flavor was spray dried with pea protein or rice protein.

| | Vegetarian | Vegetarian |
|---|---|---|
| | Process Flavor | Process Flavor |
| Sample | Chicken | Beef |
| Protein Viscosity (mPa · s) at | 350 | 270 |
| 65° C. and shear rate 50 s⁻¹ | | |
| Solubility of protein | 21 | 7 |
| (5% w/w) | | |

Vegetarian Process Flavor Chicken (containing Pea Protein) was successfully spray-dried (without the need of an additional food carrier) whereas it was not possible (without the need of an additional food carrier) to spray dry Vegetarian Process Flavor Beef Type (containing Rice Protein 80%) due to the lower solubility of the Rice Protein.

### Example 4: Sensory Evaluation of Chocolate and Vanilla Flavors in Flavored Articles Comprising Compositions According to Several Aspects Presented Herein

Pea protein (Nutralys S85F (25% by weight)) was mildly hydrolyzed with 1% w/v protease (Protamex®) at 50° C. Briefly, a small portion of pea protein powder was slowly added to deionized water in a scraped surface, steam jacketed kettle with agitation. Protamex® was added quickly to the kettle and the viscosity of protein solution decreased. The remaining of protein powder was slowly added to the kettle (over approximately 30 min). After the protein powder was fully added, the batch was kept at 50° C. with agitation for 1 hr. The temperature was then increased to 85° C. for 30 min to fully inactivate the protease. The resultant protein hydrolysate was used for spray drying encapsulation of vanilla flavor (Sample 1) and chocolate flavor (Sample 2). Two control samples were also made with conventional carrier (maltodextrin and gum arabic). The spray dry formulation was presented in below table.

| | Examples | | | |
|---|---|---|---|---|
| Composition | Control | Sample 1 | Control | Sample 2 |
| Natural flavor | 0.75 kg | 0.43 kg | | |
| (vanilla cream type) | | | | |
| Chocolate flavor | | | 0.33 kg | 0.26 kg |
| Gum arabic (Nexira) | 0.43 kg | | 3.17 kg | |
| Maltodextrin 18DE | 3.82 kg | | | |
| (Cargill USA) | | | | |
| Hydrolysate of | | 9.57 kg | | 9.74 kg |
| Nutralys S85F | | | | |
| (25% solids) | | | | |
| Water | 5.00 kg | | 6.50 kg | |
| Total | 10.00 kg | 10.00 kg | 10.00 kg | 10.00 kg |

The spray dried powders were applied to model protein beverages containing 5.9% Nutralys S85F Pea Protein, 3% sucrose and 0.2% vanilla or chocolate flavors. Descriptive sensory analysis was performed with 12 trained panels. The sensory results indicated that there were no significant differences in most descriptors and preferences against the controls. The results are shown in the tables below.

Summary of Mean-Scores, P-Values, and Significance

| | Vanilla | | | |
|---|---|---|---|---|
| Attribute | Control | Sample 1 | P-Value | Sig |
| Sweet | 5.28 | 5.18 | 0.8071 | NS |
| Salty | 2.59 | 2.73 | 0.4602 | NS |
| Bitter | 3.58 | 4.43 | 0.1081 | NS |
| Sour | 2.16 | 2.92 | 0.0427 | ** |
| Astringent | 4.76 | 4.97 | 0.6446 | NS |
| Cardboard | 4.28 | 4.76 | 0.3750 | NS |
| Oily | 2.38 | 2.73 | 0.4234 | NS |
| Creamy | 3.91 | 3.66 | 0.6945 | NS |
| Earthy | 4.56 | 4.74 | 0.7618 | NS |
| Hay | 4.30 | 3.68 | 0.0580 | * |
| Nutty | 3.69 | 3.27 | 0.2427 | NS |
| Green | 4.65 | 4.23 | 0.3331 | NS |
| Vanilla intensity | 4.26 | 3.83 | 0.5776 | NS |
| Preference | 0.67 | 0.50 | 0.0000 | NS |

| | Chocolate | | | |
|---|---|---|---|---|
| Attribute | Control | Sample 2 | P-Value | Sig |
| Sweet | 5.17 | 4.72 | 0.2656 | NS |
| Salty | 2.43 | 2.38 | 0.6801 | NS |
| Bitter | 3.55 | 3.59 | 0.5041 | NS |
| Sour | 2.83 | 2.30 | 0.5927 | NS |
| Astringent | 4.60 | 4.87 | 0.2476 | NS |
| Cardboard | 4.43 | 4.41 | 0.4021 | NS |
| Oily | 2.97 | 2.62 | 0.4153 | NS |
| Creamy | 3.88 | 4.04 | 0.3536 | NS |
| Earthy | 4.33 | 4.21 | 0.2622 | NS |
| Hay | 3.80 | 3.65 | 0.7375 | NS |
| Nutty | 4.08 | 3.79 | 0.9882 | NS |
| Green | 4.35 | 4.00 | 0.9204 | NS |
| Chocolate Intensity | 4.72 | 3.96 | 0.2887 | NS |
| Preference | 0.50 | 0.67 | 0.0000 | NS |

Note:
NS stands for not significant;
* = 0.1,
** = 0.05,
*** = 0.01

### Example 5: Sensory Evaluation of a Balsamic Vinegar Flavor Comprising Compositions According to Several Aspects Presented Herein

Blends of pea protein Nutralys S85F and sucrose at different ratios were used as spray dry carriers to encapsulate balsamic vinegar flavor at theoretical flavor oil load of 20% by weight. A control was made with modified starch and maltodextrin at theoretical flavor oil load of 16.6% by weight. The test spray dry formulas are described in the table below. Sensory evaluations were conducted in salty water at iso-load of flavor with trained panelists. All prototypes tasted the same as the control in the base of salty water at an iso-load of 0.1% flavor. No significant difference in balsamic flavor was perceived between control and prototypes except that the control has slightly more acidic note.

| | | | Test Samples | | |
|---|---|---|---|---|---|
| Composition | Control | 3 | 4 | 5 | 6 |
| Balsamic vinegar | 0.83 kg | 0.59 kg | 0.67 kg | 0.71 kg | 0.83 kg |
| flavor | | | | | |
| Modified starch | 0.42 kg | | | | |
| (Ingredion) | | | | | |
| Maltodextrin 18DE | 3.75 kg | | | | |
| (Cargill USA) | | | | | |
| PurisPea 870H | | 1.65 kg | 1.60 kg | 1.43 kg | 1.33 kg |
| (Cosucra) | | | | | |
| Sucrose | | 0.70 kg | 1.07 kg | 1.43 kg | 2.00 kg |
| Water | 5.00 kg | 7.06 kg | 6.66 kg | 6.43 kg | 5.84 kg |

### Example 6: Sensory Evaluation of a Crispy Fat Flavor Comprising Compositions According to Several Aspects Presented Herein

Crispy fat flavor was made through Maillard type of reactions (reactions between reducing sugar, amino acids, lipids, etc.), at 105° C. for 2.5 hrs. The resultant reaction flavor was a paste with 23.5% water and was spray dried with pea protein and other materials. The test spray dry formulas were described in the table below. A control was also made with gum arabic and maltodextrin as spray dry carrier. Sensory evaluations were conducted in base of salty water at iso-load of reaction flavor. The sensory results indicated that Test samples 7 and 8 were slightly weaker than the control in fatty mouthfeel and sulfur notes whereas test samples 9 and 10 were comparable to the control.

| | | | Test Samples | | |
|---|---|---|---|---|---|
| Composition | Control | 7 | 8 | 9 | 10 |
| Crispy fat | 6.62 kg | 6.80 kg | 6.80 kg | 6.93 kg | 6.93 kg |
| reaction flavor | | | | | |
| (23.5% water) | | | | | |
| Gum Arabic | 4.05 kg | | | | |
| (Nexira USA) | | | | | |
| Maltodextrin 10DE | 1.01 kg | | | | |
| (Cargill USA) | | | | | |
| Soluble corn fiber | | | 4.11 kg | | |
| (Promitor ® 85, | | | | | |
| Tate & Lyle) | | | | | |
| Soluble fiber | | 4.11 kg | | | |
| (Nutriose ® FM06, | | | | | |
| Rpquette) | | | | | |
| Pea protein | | 1.37 kg | 1.37 kg | | |
| (Nutralys F85M, | | | | | |
| Roquette USA) | | | | | |
| Pea protein | | | | 4.95 kg | 4.95 kg |
| (PurisPea 870H, | | | | | |
| Cosucra) | | | | | |
| Bitterness | | | | | 0.01 kg |
| blocker flavor | | | | | |
| Water | 8.32 kg | 7.73 kg | 7.73 kg | 16.52 kg | 16.70 kg |

Publications cited throughout this document are hereby incorporated by reference in their entirety. Although the various aspects of the invention have been illustrated above by reference to examples and preferred embodiments, it will be appreciated that the scope of the invention is defined not by the foregoing description but by the following claims properly construed under principles of patent law.

1. A composition comprising:
a) from 40 to 95% of a carrier comprising at least one non-animal protein, wherein:
i. the at least one non-animal protein has a solubility of greater than or equal to 20% and less than 99%, when measured at a protein concentration of 5% w/w in an aqueous solution, pH 7, and 25° C.;
ii. the non-animal protein has a viscosity of less than or equal to 400 mPa^{s}, when measured at 65° C. and a shear rate of 50 s⁻¹, and a protein concentration of 15% w/w in an aqueous solution; and
b) from 5 to 60% of at least one active ingredient,
the percentages being defined by weight, relative to a total weight of the composition.

2. The composition according to claim 1, wherein the solubility of the at least one non-animal protein is greater than or equal to 50% and less than 99%, when measured at a protein concentration of 5% w/w in an aqueous solution, pH 7, and 25° C.

3. The composition according to claim 1, wherein the at least one non-animal protein is hydrolyzed.

4. The composition according to claim 1, wherein the at least one non-animal protein comprises a single non-animal protein.

5. The composition according to claim 1, wherein the at least one non-animal protein comprises at least one non-animal protein.

6. The composition according to claim 1, wherein the composition comprises from 70 to 90% of the carrier.

7. The composition according to claim 1, wherein the composition comprises from 10 to 30% of the at least one active ingredient.

8. The composition according to claim 1, wherein the at least one active ingredient comprises a flavor oil.

9. The composition according to claim 1, wherein the carrier comprises from 2 to 80% of the at least one non-animal protein and from 20 to 98% soluble food materials, the percentages being defined by weight, relative to a total weight of the carrier.

10. The composition according to claim 1, wherein the at least one non-animal protein is selected from the group consisting of: pea protein, lentil protein, rice protein, potato protein, chickpea protein, fava bean protein, mung bean protein, sunflower seed protein, pumpkin seed protein, flax protein, chia protein, canola protein, lupine protein, alfalfa protein, moringa protein, and combinations thereof.

11. The composition according to claim 9, wherein the soluble food materials are selected from the group consisting of: starch hydrolysate, soluble fibers, sugars, soluble polysaccharides, exudate gums, gum arabic, inulin, beta-glucan, psyllium, glucomannan, arabinogalactan, soluble corn fiber, resistant starch, and combinations thereof.

12. A flavored article comprising the composition according to claim 1.

13. The flavored article according to claim 12, wherein the flavored article is selected from the group consisting of: protein powders, protein drinks, protein bars, meat analogues, and savory goods.
